(19) United States
(12) Patent Application Publication
(10) Pub. No.: US 2025/0370000 A1
(43) Pub. Date: Dec. 4, 2025

(54) SENSOR DATA PEAK TRACKING

(71) Applicant: STMicroelectronics International N.V., Geneva (CH)

(72) Inventors: Paolo Rosingana, Savigliano (IT); Eleonora Ferrara, Rho (IT)

(21) Appl. No.: 18/677,670

(22) Filed: May 29, 2024

(51) Int. Cl. G01P 15/08; G01P 1/02; G01P 15/18

(52) U.S. Cl. CPC G01P 15/0802; G01P 1/023; G01P 15/18

(57) ABSTRACT

An acceleration sensor circuit is disclosed. The acceleration sensor circuit includes a package; an accelerometer to generate acceleration data samples during a peak tracking window; a sample register, to store the acceleration data samples; an acceleration calculation digital circuit, to calculate an acceleration magnitude sample based on the stored acceleration data samples; a peak register, to store a current peak acceleration value; a sample compare circuit, to compare the acceleration magnitude sample to the current peak acceleration value, where the peak register is configured to replace the current peak acceleration value with the acceleration magnitude sample in response to the sample compare circuit determining that the acceleration magnitude sample is greater than the current peak acceleration value; and a memory, configured to store the current peak acceleration value, and to transmit the current peak acceleration value to an external circuit in response to an end of the peak tracking window.

### TECHNICAL FIELD

The present disclosure generally relates to generating and transmitting acceleration data, as well as to detecting and transmitting peak acceleration data.

### BACKGROUND

Some systems use acceleration sensors to sense or measure accelerations, and to generate acceleration data. For some systems, peak acceleration data for example, over a particular time duration may be particularly important.

### SUMMARY

One embodiment is an acceleration sensor circuit, including a package; an accelerometer configured to generate acceleration data samples during a peak tracking window; a sample register, configured to store the acceleration data samples; an acceleration calculation digital circuit, configured to calculate an acceleration magnitude sample based on the stored acceleration data samples; a peak register, configured to store a current peak acceleration value; a sample compare circuit, configured to compare the acceleration magnitude sample to the current peak acceleration value, where the peak register is configured to replace the current peak acceleration value with the acceleration magnitude sample in response to the sample compare circuit determining that the acceleration magnitude sample is greater than the current peak acceleration value; and a memory, configured to store the current peak acceleration value, and to transmit the current peak acceleration value to an external circuit in response to an end of the peak tracking window, where the accelerometer, the sample register, the acceleration calculation digital circuit, the peak register, the sample compare circuit, and the memory are enclosed in the package.

Another embodiment is a system, including a system controller; a plurality of system components configured to operate in response to control signals from the system controller; an acceleration sensor circuit package; an accelerometer configured to generate acceleration data samples during a peak tracking window; a sample register, configured to store the acceleration data samples; an acceleration calculation digital circuit, configured to calculate an acceleration magnitude sample based on the stored acceleration data samples; a peak register, configured to store a current peak acceleration value; a sample compare circuit, configured to compare the acceleration magnitude sample to the current peak acceleration value, where the peak register is configured to replace the current peak acceleration value with the acceleration magnitude sample in response to the sample compare circuit determining that the acceleration magnitude sample is greater than the current peak acceleration value; and a memory, configured to store the current peak acceleration value, and to transmit the current peak acceleration value to an external circuit in response to an end of the peak tracking window, where the accelerometer, the sample register, the acceleration calculation digital circuit, the peak register, the sample compare circuit, and the memory are enclosed in the acceleration sensor circuit package.

Another embodiment is a method of forming an acceleration sensor circuit, the method including providing a package; providing an accelerometer configured to generate acceleration data samples during a peak tracking window; providing a sample register, configured to store the acceleration data samples; providing an acceleration calculation digital circuit, configured to calculate an acceleration magnitude sample based on the stored acceleration data samples; providing a peak register, configured to store a current peak acceleration value; providing a sample compare circuit, configured to compare the acceleration magnitude sample to the current peak acceleration value, where the peak register is configured to replace the current peak acceleration value with the acceleration magnitude sample in response to the sample compare circuit determining that the acceleration magnitude sample is greater than the current peak acceleration value; providing a memory, configured to store the current peak acceleration value, and to transmit the current peak acceleration value to an external circuit in response to an end of the peak tracking window; and packaging the accelerometer, the sample register, the acceleration calculation digital circuit, the peak register, the sample compare circuit, and the memory in the package.

Another embodiment is a method of using an acceleration sensor circuit, the method including detecting a signal indicating that a peak tracking window is to start; accessing acceleration data; calculating a current acceleration magnitude based on the acceleration data; in response to the current acceleration magnitude being greater than a current peak acceleration value storing the current acceleration magnitude sample as the current peak acceleration value; in response to the current acceleration magnitude sample not being greater than the current peak acceleration value, not storing the current acceleration magnitude as the current peak acceleration value; and in response to the peak tracking window having ended, transmitting data related to the current peak acceleration value to a memory, and initializing the current peak acceleration value.

### BRIEF DESCRIPTION OF THE DRAWINGS

For a more complete understanding of one or more embodiments of the present disclosure, and the advantages thereof, reference is now made to the following descriptions taken in conjunction with the accompanying drawings, in which:

FIG. 1 shows a schematic circuit block diagram of a system using an acceleration sensor according to some embodiments.

FIG. 2 shows a schematic circuit block diagram of a peak tracking system used in the system of FIG. 1 according to some embodiments.

FIG. 3 shows a schematic circuit block diagram of a peak tracking system used in the system of FIG. 1 according to some embodiments.

FIG. 4 shows a graph diagram illustrating acceleration data and peak acceleration data according to some embodiments.

FIG. 5 shows a flowchart diagram illustrating a method of using an acceleration sensor according to some embodiments.

FIG. 6 shows a flowchart diagram illustrating a method of using an acceleration sensor according to some embodiments.

FIG. 7 shows a flowchart diagram illustrating a method of using a system having an acceleration sensor according to some embodiments.

FIG. 8 shows a flowchart diagram illustrating a method of using a system having an acceleration sensor according to some embodiments.

Corresponding numerals and symbols in the different figures generally refer to corresponding parts unless otherwise indicated. The figures are drawn to illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

Illustrative embodiments of the system and method of the present disclosure are described below. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

Reference may be made herein to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

In some embodiments, detection of high acceleration events or shocks may use high bandwidth and high output data rate, for example, because to detect the high acceleration events, the acceleration sensor may need to transmit all acceleration sensor data to the system for processing, for example, for peak detection. In such systems, the detection of a maximum peaks in the acceleration data caused by the high acceleration events requires storing and transmission of large amounts of data. In some embodiments, the techniques and features discussed herein are used for other data or other sensor data including other types of MEMS sensors.

In some embodiments, peak acceleration detection in each of multiple dimensions may be performed, for example, at or near a peripheral portion of the sensor. In some embodiments, the peak acceleration detection system determines a peak acceleration in each of multiple dimensions, or as a magnitude corresponding with accelerations in any or all of the multiple dimensions.

In some embodiments, the peak acceleration detection system determines a peak acceleration over a particular window of time. In some embodiments, the particular window is a programmable duration. In some embodiments, a series of consecutive windows generate a series of peak acceleration data. In some embodiments, a window is initiated by a detected event, for example, based on acceleration data.

In some embodiments, acceleration data or peak acceleration data greater than a threshold may be reported to a system controller, for example, as an interrupt. In some embodiments, acceleration data or peak acceleration data greater than the threshold may cause acceleration data or peak acceleration data to be stored in a memory, for example configured as a first in first out (FIFO) memory structure.

In some embodiments, the window can be enabled and disabled, for example, by the system controller, depending on the acceleration profile or other monitored aspects. In some embodiments, at the end of the window, the acceleration data, and, in some embodiments, timestamp data related to the peak is sent and stored in a memory.

In some embodiments, because minimal data is transmitted from the sensor to the system, use of the sensor generates a low computational load on the system controller.

In some embodiments, the machine learning system may be used to determine one or more parameters used by the peak acceleration detection system, such as conditions for starting a window, conditions for ending a window, and window duration.

The peak acceleration data detector may be implemented in any of a number of different ways. For example, in some embodiments, the peak acceleration data detector is implemented using programmable embedded microcontroller. In some embodiments, the peak acceleration data detector is implemented using hard-coded logic with limited or no configurability. In some embodiments, the peak acceleration data detector is implemented as an ASIC.

FIG. 1 shows a schematic circuit block diagram of a system 100 using an acceleration sensor 115 according to some embodiments. System 100 is an example only, and is not intended to be limiting, unless explicitly stated. In some embodiments, system 100 is or includes a phone. In some embodiments, system 100 is or includes a wearable electronic device. In some embodiments, system 100 is or includes a computing device or other mobile electronic device.

System 100 includes system controller 155 and system components 165.

System controller 155 is configured to electronically interface with system components 165, and to cause system components 165 to perform the various functions expected of system 100. For example, in embodiments where system 100 is or includes a phone, system controller 155 is configured to interface with system components 165 to cause system 100 to send and receive phone calls, to send and receive text messages, and to perform other functions, according to the capabilities of the phone.

System 100 also includes an acceleration sensor 115. Acceleration sensor 115 is an example only, and is not intended to be limiting, unless explicitly stated. In some embodiments, acceleration sensor is a single device, for example, enclosed by a single package. In some embodiments, acceleration sensor 115 is formed on a single semiconductor die, which is packaged as an integrated circuit chip.

Acceleration sensor 115 includes accelerometer 118, peak tracking system 128, and FIFO memory 138. In some embodiments, accelerometer 118 is fabricated using, for example, a MEMS technology. In some embodiments, accelerometer 118 is packaged with a separate ASIC that includes all the analog/digital circuit needed to convert the sensed acceleration into digital data. For example, the ASIC may include or incorporate the functionality of peak tracking system 128 and FIFO memory 138. Accordingly, in some embodiments, acceleration sensor 115 is formed in a package having internal devices including a MEMs technology accelerometer 118 and an ASIC having peak tracking system 128 and FIFO memory 138 formed thereon.

Accelerometer 118 senses accelerations experienced by system 100. For example, accelerometer 118 be any accelerometer configured to generate a series of acceleration measurements in each of 1, 2, or 3 spatial dimensions. In some embodiments, accelerometer 118 senses and generates acceleration measurements for spatial dimensions corresponding with those spatial dimensions of movement of a mechanical mass or of a mechanical oscillating mass. For example, in some embodiments, accelerometer 118 generates acceleration measurements for spatial dimensions, in which sufficient acceleration disturbs the position or oscillation operation of the mass of the accelerometer 118.

Peak tracking system 128 is configured to receive acceleration data from accelerometer 118, and to determine peak acceleration values the received acceleration data. In addition, peak tracking system 128 may be configured to transmit the peak acceleration values to FIFO memory 138 and/or to system controller 155.

In some embodiments, peak tracking system 128 is configured to receive a series of multidimensional acceleration data samples from accelerometer 118. In addition, the peak tracking system 128 may be configured to calculate a total acceleration or an acceleration magnitude sample based on each sample of the multidimensional acceleration data.

Peak tracking system 128 may be further configured to compare a current acceleration magnitude sample with a current peak acceleration magnitude value, for example, stored in a peak value register. In response to the current acceleration magnitude sample being greater than the current peak acceleration magnitude value, peak tracking system 128 stores the current acceleration magnitude sample in the peak value register. In some embodiments, storing the current acceleration magnitude sample in the peak value register replaces the peak acceleration magnitude value previously stored therein.

In some embodiments, peak tracking system 128 successively compares current acceleration magnitude samples with the currently stored peak acceleration value. In some embodiments, the current acceleration magnitude samples are generated for a peak tracking window.

In some embodiments, peak tracking system 128 determines the start and end of each peak tracking window based on information from system controller 155. For example, peak tracking system 128 may have received information from system controller 155 specifying lengths or durations of peak tracking windows. In some embodiments, the information from system controller 155 may specify a number of samples. Therefore, in some embodiments, peak tracking system 128 ends a peak tracking window after having processed a number of acceleration magnitude samples corresponding with the window information received from system controller 155.

In some embodiments, in response to the peak tracking window ending, peak tracking system 128 transmits data related to the peak acceleration value stored in the peak value register. In some embodiments, the transmitted data includes one or more of: the calculated peak acceleration value, the multidimensional acceleration data samples used to calculate the peak acceleration value, and a timestamp value corresponding with a time of the peak acceleration value.

For example, in some embodiments, system controller 155 is configured to provide system time information to peak tracking system 128, and, in response to determining that a current acceleration magnitude sample is greater than the currently stored peak acceleration magnitude value, peak tracking system 128, in addition to storing the current acceleration magnitude sample in the peak value register, also stores data corresponding with a timestamp value indicating a time of the current acceleration magnitude sample. In some embodiments, the time of the current acceleration magnitude sample corresponds with the system time when the multidimensional acceleration data samples used to calculate the current acceleration magnitude sample were received from accelerometer 118.

In some embodiments, the peak tracking windows are successive, such that the end of a first peak tracking window corresponds with the beginning of a second peak tracking window. In some embodiments, the last acceleration magnitude sample of the first peak tracking window is adjacent in time to the first acceleration magnitude sample of the second peak tracking window. Accordingly, in some embodiments, the end of the first peak tracking window triggers the beginning of the second peak tracking window.

In some embodiments, the window information from system controller 155 causes peak tracking system 128 to continuously monitor acceleration magnitude samples to determine conditions for starting a next peak tracking window. For example, during a time outside of any peak tracking window, peak tracking system 128 may be configured to receive multidimensional acceleration data samples from accelerometer 118, and to calculate a total acceleration or an acceleration magnitude sample based on each sample of the multidimensional acceleration data.

Peak tracking system 128 may be further configured to compare each current acceleration magnitude sample with a threshold acceleration magnitude value, for example, stored in a threshold register. In response to the current acceleration magnitude sample being greater than the threshold acceleration magnitude value, peak tracking system 128 may be configured to start a peak tracking window, during which peak tracking system 128 compares each current acceleration magnitude sample with a current peak acceleration magnitude value stored in the peak value register, and in response to the current acceleration magnitude sample being greater than the current peak acceleration magnitude value, store the current acceleration magnitude sample in the peak value register.

In some embodiments, in response to the current acceleration magnitude sample being greater than the threshold acceleration magnitude value, peak tracking system 128 is configured to generate, store, and transmit acceleration data during a peak tracking window having a specified duration and having started in response to the current acceleration magnitude sample being greater than the threshold acceleration magnitude value. In some embodiments, in response to the current acceleration magnitude sample being greater than the threshold acceleration magnitude value, peak tracking system 128 is configured to generate, store, and transmit peak acceleration data during a specified quantity of peak tracking windows each having a specified duration. Some embodiments use other criteria to start and/or end the peak tracking window. For example, in some embodiments, a peak tracking window can be started in response to detecting a free-fall condition, a condition of o acceleration, or a condition of acceleration less than a predetermined threshold. In some embodiments, a peak tracking window is started or ended based on data from one or more other sensors, such as a gyroscope.

In some embodiments, in response to the current acceleration magnitude sample being greater than the threshold acceleration magnitude value, peak tracking system 128 transmits an alert to system controller 155. In response to the alert, system controller 155 may be configured to alter operation of one or more of the system components 165, for example, to mitigate adverse effects of a high acceleration event experienced by system 100.

In some embodiments, in response to the alert, system controller 155 may be configured to transmit a command to acceleration sensor 115 which causes acceleration sensor 115 to transmit acceleration data stored in FIFO memory 138 to system controller 155. In some embodiments, in response to the alert, system controller 155 is configured to transmit a command to acceleration sensor 115 causing acceleration sensor 115 to generate, store, and transmit acceleration data during a peak tracking window having a specified duration and having started in response to the current acceleration magnitude sample being greater than the threshold acceleration magnitude value. In some embodiments, in response to the alert, system controller 155 is configured to transmit a command to acceleration sensor 115 causing acceleration sensor 115 to generate, store, and transmit peak acceleration data during a specified quantity of peak tracking windows each having a specified duration.

FIFO memory 138 is configured to store peak acceleration data received from peak tracking system 128, and is configured to transmit stored peak acceleration data to system controller 155, for example, in response to commands from either system controller 155 or peak tracking system 128.

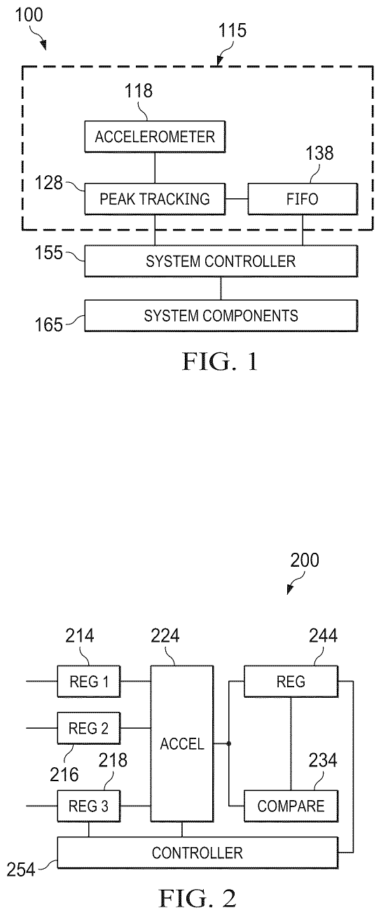

FIG. 2 shows a schematic circuit block diagram of a peak tracking system 200 according to some embodiments. In some embodiments, peak tracking system 200 is used in the system of FIG. 1 as peak tracking system 128. In some embodiments, acceleration sensor 115 uses a different peak tracking system having features similar or identical to peak tracking system 200. Peak tracking system 200 is an example only, and is not intended to be limiting, unless explicitly stated. In some embodiments, peak tracking system 200 is implemented as a programmable circuit, such as a processor or microprocessor, executing instructions which cause the programmable circuit to perform the functions discussed herein. In some embodiments, peak tracking system 200 is implemented in circuitry of an integrated circuit, such as an application specific integrated circuit (ASIC). In some embodiments, peak tracking system 200 is implemented in circuitry of an integrated circuit, such as an application specific integrated circuit (ASIC) and is integrated with a FIFO, such as FIFO memory 138.

Peak tracking system 200 is configured to receive three-dimensional acceleration data samples from an accelerometer, such as accelerometer 118. Other embodiments are configured to receive one-or two-dimensional acceleration data samples from an accelerometer.

Peak tracking system 200 includes sample registers 214, 216, and 218, acceleration calculation digital circuit 224, compare circuit 234, peak register 244, and controller 254.

Sample registers 214, 216, and 218 are configured to receive the three-dimensional acceleration data samples from the accelerometer, where each of Sample registers 214, 216, and 218 successively receive acceleration data samples for one of the three dimensions. Sample registers 214, 216, and 218 are also configured to store the acceleration data samples, for example, according to a clock signal or other control signal received from controller 254. Sample registers 214, 216, and 218 additionally transmit the respective acceleration data samples to acceleration calculation digital circuit 224.

Acceleration calculation digital circuit 224 receives the acceleration data samples from Sample registers 214, 216, and 218, and is configured to calculate the mathematical square of each of the acceleration data samples. In some embodiments, acceleration calculation digital circuit 224 also generates a total acceleration or an acceleration magnitude sample based on the sum of the calculated mathematical squares, for example, according to a clock signal or other control signal received from controller 254. Acceleration calculation digital circuit 224 also transmits the acceleration magnitude sample to compare circuit 234 and to peak register 244. Acceleration calculation digital circuit 224 may be implemented as a programmable circuit, such as a processor or microprocessor, executing instructions which cause the programmable circuit to perform the functions discussed herein. In some embodiments, acceleration calculation digital circuit 224 is implemented in circuitry of an integrated circuit, such as an application specific integrated circuit (ASIC). In some embodiments, acceleration calculation digital circuit 224 is integrated with circuitry which performs the functionality of other components of peak tracking system 200. Any digital processing circuitry may be used to implement acceleration calculation digital circuit 224.

Compare circuit 234 receives the acceleration magnitude sample from acceleration calculation digital circuit 224. Compare circuit 234 also receives a current peak acceleration value from peak register 244. In some embodiments, compare circuit 234 is configured to compare the acceleration magnitude sample with the current peak acceleration value, and to generate a compare signal indicating whether the acceleration magnitude sample is greater than the current peak acceleration value, for example, according to a clock signal or other control signal received from controller 254.

Peak register 244 is configured to receive the acceleration magnitude sample from acceleration calculation digital circuit 224. Peak register 244 is also configured to receive the compare signal from compare circuit 234. In some embodiments, peak register 244 is configured to conditionally store the acceleration magnitude sample based on the compare signal, for example, according to a clock signal or other control signal received from controller 254. For example, in response to the compare signal indicating that the acceleration magnitude sample is not greater than the current peak acceleration value, peak register 244 may be configured to not store the acceleration magnitude sample. In contrast, in response to the compare signal indicating that the acceleration magnitude sample is greater than the current peak acceleration value, peak register 244 may be configured to store the acceleration magnitude sample as the current peak acceleration value. In some embodiments, storing the acceleration magnitude sample as the current peak acceleration value replaces the previous current peak acceleration value.

Peak register 244 is additionally configured to transmit the current peak acceleration value to compare circuit 234. In some embodiments, peak register 244 is configured to transmit the current peak acceleration value to controller 254, for example, in response to a stop peak tracking window signal received from controller 254.

When used in an acceleration sensor, such as acceleration sensor 115, controller 254 may be configured to transmit the current peak acceleration value to an external circuit, such as a FIFO memory, such as FIFO memory 138. In some embodiments, controller 254 is configured to transmit the current peak acceleration value to the external circuit in response to a clock signal or other control signal received from, for example, the external circuit, or another circuit, such as an external controller, such as system controller 155.

In some embodiments, the controller 254 is configured to generate the clock signals or other control signals so that peak tracking system 200 identifies, stores, and transmits peak acceleration values occurring during peak tracking windows. In some embodiments, the peak tracking windows are determined by controller 254, for example, based on data calculated by acceleration calculation digital circuit. In some embodiments, the peak tracking windows are determined, for example, based partly or wholly on information received by controller 254 from external circuitry, such as an external controller.

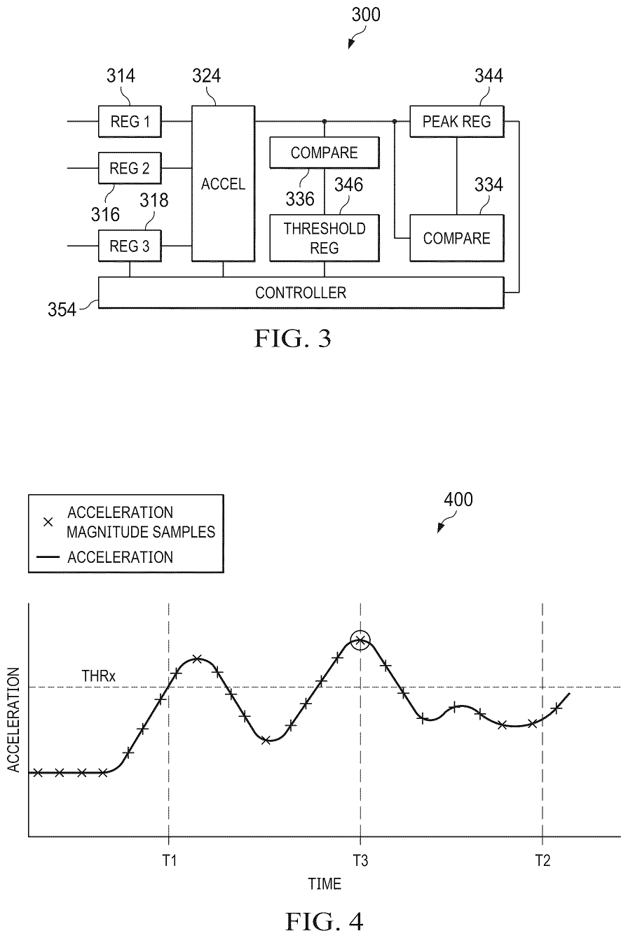

FIG. 3 shows a schematic circuit block diagram of a peak tracking system 300 according to some embodiments. In some embodiments, peak tracking system 300 is used in the system of FIG. 1 as peak tracking system 120. In some embodiments, acceleration sensor 115 uses a different peak tracking system having features similar or identical to peak tracking system 300. Peak tracking system 300 is an example only, and is not intended to be limiting, unless explicitly stated. In some embodiments, peak tracking system 300 is implemented as a programmable circuit, such as a processor or microprocessor, executing instructions which cause the programmable circuit to perform the functions discussed herein. In some embodiments, peak tracking system 300 is implemented in circuitry of an integrated circuit, such as an application specific integrated circuit (ASIC). In some embodiments, peak tracking system 300 is implemented in circuitry of an integrated circuit, such as an application specific integrated circuit (ASIC) and is integrated with a FIFO, such as FIFO memory 138.

Peak tracking system 300 is configured to receive three-dimensional acceleration data samples from an accelerometer, such as accelerometer 118. Other embodiments are configured to receive one-or two-dimensional acceleration data samples from an accelerometer.

Peak tracking system 300 includes registers 314, 316, and 318, acceleration calculation digital circuit 324, compare circuit 336, threshold register 346, compare circuit 334, peak register 344, and controller 354. Compare circuit 336, threshold register 346, compare circuit 334, peak register 344, and controller 354 may form or be part of a configurable finite state machine. In some embodiments, the configurable finite state machine is configurable by a system controller, such as system controller 155.

Registers 314, 316, and 318 are configured to receive the three-dimensional acceleration data samples from the accelerometer, where each of registers 314, 316, and 318 successively receive acceleration data samples for one of the three dimensions. Registers 314, 316, and 318 are also configured to store the acceleration data samples, for example, according to a clock signal or other control signal received from controller 354. Registers 314, 316, and 318 additionally transmit the respective acceleration data samples to acceleration calculation digital circuit 324.

Acceleration calculation digital circuit 324 receives the acceleration data samples from registers 314, 316, and 318, and is configured to calculate the mathematical square of each of the acceleration data samples. In some embodiments, acceleration calculation digital circuit 324 also generates a total acceleration or an acceleration magnitude sample based on the sum of the calculated mathematical squares, for example, according to a clock signal or other control signal received from controller 354. Acceleration calculation digital circuit 324 also transmits the acceleration magnitude sample to compare circuit 334 and to peak register 344. Acceleration calculation digital circuit 324 may be implemented as a programmable circuit, such as a processor or microprocessor, executing instructions which cause the programmable circuit to perform the functions discussed herein. In some embodiments, acceleration calculation digital circuit 324 is implemented in circuitry of an integrated circuit, such as an application specific integrated circuit (ASIC). In some embodiments, acceleration calculation digital circuit 324 is integrated with circuitry which performs the functionality of other components of peak tracking system 300. Any digital processing circuitry may be used to implement acceleration calculation digital circuit 324.

Compare circuit 336 receives the acceleration magnitude sample from acceleration calculation digital circuit 324. Compare circuit 336 also receives a threshold acceleration value from threshold register 346. In some embodiments, compare circuit 336 is configured to compare the acceleration magnitude sample with the threshold acceleration value, and to generate a threshold compare signal indicating whether the acceleration magnitude sample is greater than the threshold acceleration value, for example, according to a clock signal or other control signal received from controller 354.

Threshold register 346 is configured to receive the threshold acceleration value from controller 354.

Compare circuit 336 may be additionally configured to transmit the threshold compare signal to controller 354 and, in some embodiments, directly to compare circuit 334, for example, in response to a clock signal or other control signal received from controller 354.

In some embodiments, controller 354 is configured to receive the threshold compare signal from compare circuit 336, and, in response to the threshold compare signal, to transmit a start peak tracking window signal to compare circuit 334.

Some embodiments use other criteria to start and/or end the peak tracking window. For example, in some embodiments, a peak tracking window can be started in response to detecting a free-fall condition, a condition of o acceleration, or a condition of acceleration less than a predetermined threshold. In some embodiments, a peak tracking window is started or ended based on data from one or more other sensors, such as a gyroscope.

Compare circuit 334 receives the acceleration magnitude sample from acceleration calculation digital circuit 324. Compare circuit 334 also receives a current peak acceleration value from peak register 344. In some embodiments, in response to receiving the start peak tracking window signal from controller 354, compare circuit 334 is configured to compare the acceleration magnitude sample with the current peak acceleration value, and to generate a compare signal indicating whether the acceleration magnitude sample is greater than the current peak acceleration value, for example, according to a clock signal or other control signal received from controller 354.

Peak register 344 is configured to receive the acceleration magnitude sample from acceleration calculation digital circuit 324. Peak register 344 is also configured to receive the compare signal from compare circuit 334. In some embodiments, peak register 344 is configured to conditionally store the acceleration magnitude sample based on the compare signal, for example, according to a clock signal or other control signal received from controller 354. For example, in response to the compare signal indicating that the acceleration magnitude sample is not greater than the current peak acceleration value, peak register 344 may be configured to not store the acceleration magnitude sample. In contrast, in response to the compare signal indicating that the acceleration magnitude sample is greater than the current peak acceleration value, peak register 344 may be configured to store the acceleration magnitude sample as the current peak acceleration value. In some embodiments, storing the acceleration magnitude sample as the current peak acceleration value replaces the previous current peak acceleration value.

Peak register 344 is additionally configured to transmit the current peak acceleration value to compare circuit 334. In some embodiments, peak register 344 is configured to transmit the current peak acceleration value to controller 354, for example, in response to a stop peak tracking window signal received from controller 354.

When used in an acceleration sensor, such as acceleration sensor 115, controller 354 may be configured to transmit the current peak acceleration value to an external circuit, such as a FIFO memory, such as FIFO memory 138. In some embodiments, controller 354 is configured to transmit the current peak acceleration value to the external circuit in response to a clock signal or other control signal received from, for example, the external circuit, or another circuit, such as a controller, such as system controller 155.

In some embodiments, the controller 354 is configured to generate the clock signals or other control signals so that peak tracking system 300 identifies, stores, and transmits peak acceleration values occurring during peak tracking windows determined, for example, based on information received by controller 354 from external circuitry, such as an external controller.

FIG. 4 shows a graph diagram illustrating acceleration data and peak acceleration data of an acceleration sensor according to some embodiments. The continuous curve represents the magnitude of acceleration experienced by the acceleration sensor, such as acceleration sensor 115. The indicated x points represent acceleration magnitude samples calculated by the acceleration sensor.

At time T1, the acceleration sensor starts a peak tracking window. In some embodiments, the peak tracking window starts as a result of the most recent acceleration magnitude sample being greater than a threshold acceleration THRx. In some embodiments, a controller causes the peak tracking window to start as a result of other algorithmic factors, for example, as discussed elsewhere herein.

During the peak tracking window, the acceleration sensor stores acceleration data for each acceleration magnitude sample which is greater than all of the previous acceleration magnitude samples of the peak tracking window. In some embodiments, the acceleration sensor stores the acceleration magnitude sample. In some embodiments, the acceleration sensor stores acceleration data samples used to calculate the acceleration magnitude sample. In some embodiments, the acceleration sensor stores a timestamp corresponding with a time of the acceleration data samples used to calculate the acceleration magnitude sample.

At time T2, the acceleration sensor ends the peak tracking window. In some embodiments, the peak tracking window ends as a result of a time passed or a number of samples taken after the start of the peak tracking window or, for example, after a last peak detected, or, for example, after the last sample higher than a specific value. In some embodiments, the controller causes the peak tracking window to end as a result of other algorithmic factors, for example, as discussed elsewhere herein.

After the peak tracking window ends, the acceleration sensor may be configured to transmit the stored acceleration data to an external circuit, such as a system controller, such as system controller 155.

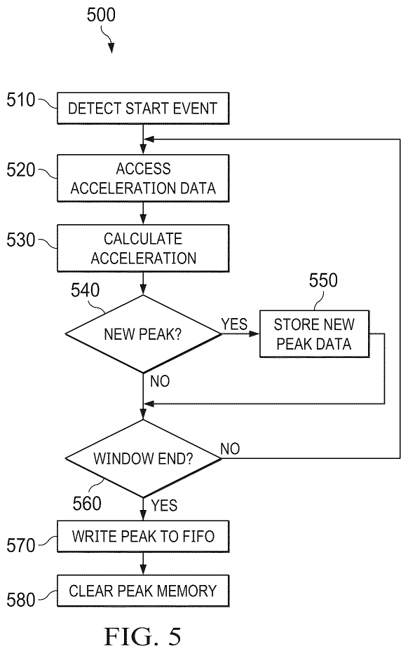

FIG. 5 shows a flowchart diagram illustrating a method 500 of using an acceleration sensor according to some embodiments. The method 500 may be performed, for example by an acceleration sensor, such as acceleration sensor 115, or a system, such as system 100.

At block 510, the acceleration sensor or system detects or determines an event or signal indicating that a peak tracking window is to start. In some embodiments, the event or signal indicates that an amount of time has passed since the start of the peak tracking window. In some embodiments, the event or signal indicates that a number of samples have been taken since the start of the peak tracking window. In some embodiments, the event or signal indicates that a previous peak tracking window has ended, and a new peak tracking window is to start.

At block 520, the acceleration sensor or system accesses acceleration data. In some embodiments, one-, two-, or three-dimensional acceleration data samples are successively accessed and stored.

At block 530, if the acceleration data samples are multidimensional, a mathematical square of each of the acceleration data samples is calculated. In addition, a total acceleration or an acceleration magnitude sample is calculated based on the sum of the calculated mathematical squares. In embodiments, where the acceleration data samples are unidimensional, the acceleration data samples may be used as the acceleration magnitude samples.

At block 540, a current acceleration magnitude sample is compared with a current peak acceleration value.

In response to the current acceleration magnitude sample being greater than the current peak acceleration value, at block 550, the current acceleration magnitude sample is stored as an updated current peak acceleration value. In some embodiments, data related to the current acceleration magnitude sample is additionally stored. In response to the current acceleration magnitude sample not being greater than the current peak acceleration value, the current acceleration magnitude sample is not stored as an updated current peak acceleration value.

At block 560, a determination is made as to whether the current peak tracking window has ended. If the current peak tracking window has not ended, at block 520, a next acceleration data sample is accessed.

If, at block 560, the current peak tracking window has ended, at block 570, data related to the current peak acceleration value is transmitted to a memory, such as a FIFO memory. In some embodiments, at block 570, data related to the current peak acceleration value is transmitted to an external circuit, such as a system controller.

At block 580, the memory used to store the data related to the current peak acceleration value is initialized, for example, to a zero value.

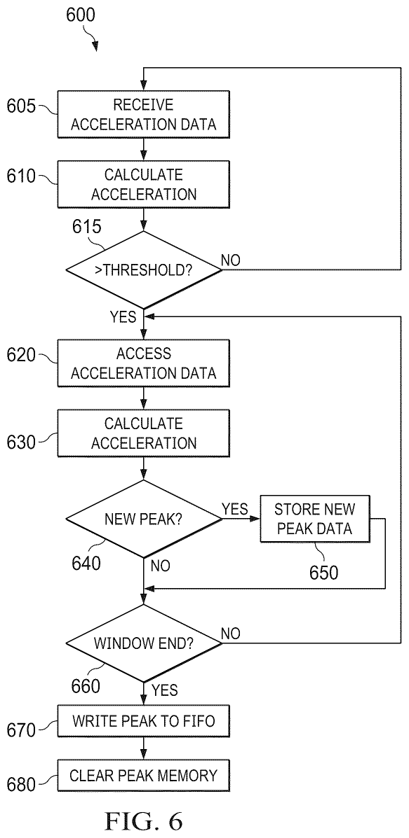

FIG. 6 shows a flowchart diagram illustrating a method 600 of using an acceleration sensor according to some embodiments. The method 600 may be performed, for example by an acceleration sensor, such as acceleration sensor 115, or a system, such as system 100. In some embodiments, the method 600 may be performed, for example by a finite state machine of an acceleration sensor, such as acceleration sensor 115, or a system, such as system 100.

At block 605, the acceleration sensor or system accesses a sample of acceleration data. In some embodiments, one-, two-, or three-dimensional acceleration data samples are successively accessed and stored.

At block 610, if the acceleration data samples are multidimensional, a mathematical square of each of the acceleration data samples is calculated. In addition, a total acceleration or an acceleration magnitude sample is calculated based on the sum of the calculated mathematical squares. In embodiments, where the acceleration data samples are unidimensional, the acceleration data samples may be used as the acceleration magnitude samples.

At block 615, a current acceleration magnitude sample is compared with a threshold acceleration value.

In response to the current acceleration magnitude sample being not greater than the threshold acceleration value, at block 605, the acceleration sensor or system accesses a next sample of acceleration data.

In response to the current acceleration magnitude sample being greater than the threshold acceleration value, at block 620, the acceleration sensor or system accesses a current acceleration data sample.

At block 630, if the acceleration data samples are multidimensional, a mathematical square of each of the acceleration data samples is calculated. In addition, a total acceleration or an acceleration magnitude sample is calculated based on the sum of the calculated mathematical squares. In embodiments, where the acceleration data samples are unidimensional, the acceleration data samples may be used as the acceleration magnitude samples.

At block 640, a current acceleration magnitude sample is compared with a current peak acceleration value.

In response to the current acceleration magnitude sample being greater than the current peak acceleration value, at block 650, the current acceleration magnitude sample is stored as an updated current peak acceleration value. In some embodiments, data related to the current acceleration magnitude sample is additionally stored. In response to the current acceleration magnitude sample not being greater than the current peak acceleration value, the current acceleration magnitude sample is not stored as an updated current peak acceleration value.

At block 660, a determination is made as to whether the current peak tracking window has ended. If the current peak tracking window has not ended, at block 620, a next acceleration data sample is accessed.

If, at block 660, the current peak tracking window has ended, at block 670, data related to the current peak acceleration value is transmitted to a memory, such as a FIFO memory. In some embodiments, at block 670, data related to the current peak acceleration value is transmitted to an external circuit, such as a system controller.

At block 680, the memory used to store the data related to the current peak acceleration value is initialized, for example, to a zero value.

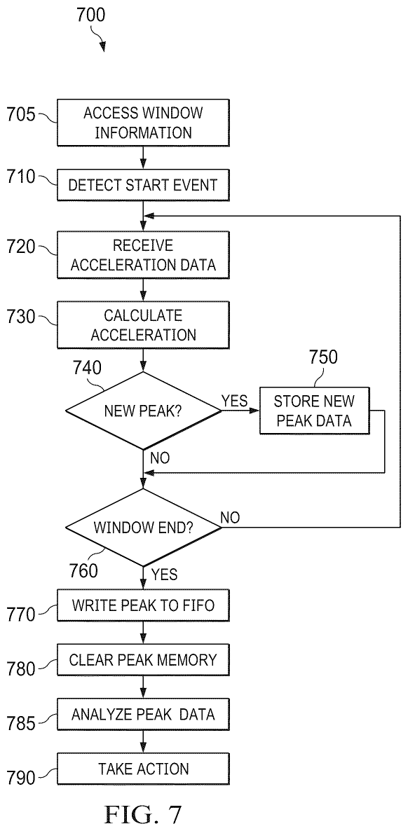

FIG. 7 shows a flowchart diagram illustrating a method 700 of using an acceleration sensor according to some embodiments. The method 700 may be performed, for example by an acceleration sensor, such as acceleration sensor 115, or a system, such as system 100. In some embodiments, the method 700 may be performed, for example by a finite state machine of an acceleration sensor, such as acceleration sensor 115, or a system, such as system 100.

At block 705, a controller, such as the finite state machine, accesses peak tracking window information. In some embodiments, the peak tracking window information includes an amount of time defining a duration for the peak tracking window. In some embodiments, the peak tracking window information includes a sampling frequency for taking samples during the peak tracking window. In some embodiments, the peak tracking window information includes a number of samples to be taken during the peak tracking window. In some embodiments, the peak tracking window information includes one or more conditions for starting the peak tracking window. In some embodiments, the peak tracking window information includes one or more conditions for stopping the peak tracking window.

At block 710, the acceleration sensor or system detects or determines an event or signal indicating that a peak tracking window is to start, for example in accordance with the peak tracking window information received at block 705. In some embodiments, the event or signal indicates that a previous peak tracking window has ended, and a new peak tracking window is to start.

At block 720, the acceleration sensor or system accesses acceleration data. In some embodiments, one-, two-, or three-dimensional acceleration data samples are successively accessed and stored.

At block 730, if the acceleration data samples are multidimensional, a mathematical square of each of the acceleration data samples is calculated. In addition, a total acceleration or an acceleration magnitude sample is calculated based on the sum of the calculated mathematical squares. In embodiments, where the acceleration data samples are unidimensional, the acceleration data samples may be used as the acceleration magnitude samples.

At block 740, a current acceleration magnitude sample is compared with a current peak acceleration value.

In response to the current acceleration magnitude sample being greater than the current peak acceleration value, at block 750, the current acceleration magnitude sample is stored as an updated current peak acceleration value. In some embodiments, data related to the current acceleration magnitude sample is additionally stored. In response to the current acceleration magnitude sample not being greater than the current peak acceleration value, the current acceleration magnitude sample is not stored as an updated current peak acceleration value.

At block 760, a determination is made as to whether the current peak tracking window has ended. If the current peak tracking window has not ended, at block 720, a next acceleration data sample is accessed.

If, at block 760, the current peak tracking window has ended, at block 770, data related to the current peak acceleration value is transmitted to a memory, such as a FIFO memory. In some embodiments, at block 770, data related to the current peak acceleration value is transmitted to an external circuit, such as a system controller.

At block 780, the memory used to store the data related to the current peak acceleration value is initialized, for example, to a zero value.

At block 785, the peak acceleration data stored in the memory at block 770 is received from the memory at a controller, such as a system controller. In addition, the peak acceleration data is analyzed by the controller. For example, in some embodiments, an acceleration peak magnitude is compared with a threshold value, and in response to the acceleration peak magnitude being greater than the threshold value, at 790, the controller may cause one or more actions to be taken. For example, the controller may cause the system to alert a user of the system or another party of a shock event. In some embodiments, the system sends a message to an emergency response system or agency. In some embodiments, the alert or message may include representations of various peak acceleration data. For example, the alert or message may include representations of one or more of: the magnitude of the peak acceleration, a direction of the peak acceleration, and a time of the peak acceleration. In some embodiments, the system stores an indication that the shock event occurred as an indication that a warranty of the system is no longer valid. In some embodiments, the system stores multiple threshold values, and determines actions to take based on which, if any of the multiple threshold values, the peak acceleration is greater than.

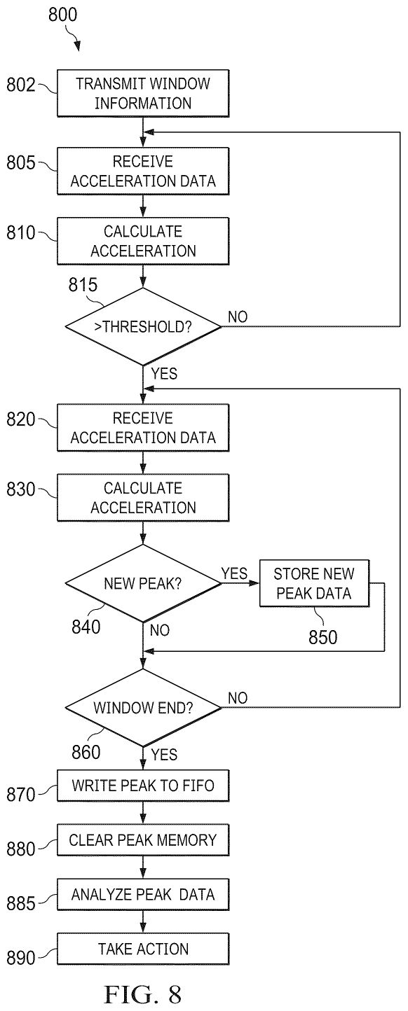

FIG. 8 shows a flowchart diagram illustrating a method 800 of using a system having an acceleration sensor according to some embodiments. The method 800 may be performed, for example by an acceleration sensor, such as acceleration sensor 115, or a system, such as system 100. In some embodiments, the method 800 may be performed, for example by a finite state machine of an acceleration sensor, such as acceleration sensor 115, or a system, such as system 100.

At block 802, a controller, such as system controller 155, transmits peak tracking window information to an acceleration sensor, such as acceleration sensor 115. In some embodiments, the peak tracking window information includes an amount of time defining a duration for the peak tracking window. In some embodiments, the peak tracking window information includes a sampling frequency for taking samples during the peak tracking window. In some embodiments, the peak tracking window information includes a number of samples to be taken during the peak tracking window. In some embodiments, the peak tracking window information includes one or more conditions for starting the peak tracking window. In some embodiments, the peak tracking window information includes one or more conditions for stopping the peak tracking window.

In the illustrated embodiment, the peak tracking window information includes an acceleration magnitude threshold, and the system is configured to start a peak tracking window in response to a sensed acceleration magnitude being greater than the acceleration magnitude threshold.

At block 805, the acceleration sensor or system accesses a sample of acceleration data. In some embodiments, one-, two-, or three-dimensional acceleration data samples are successively accessed and stored.

At block 810, if the acceleration data samples are multidimensional, a mathematical square of each of the acceleration data samples is calculated. In addition, a total acceleration or an acceleration magnitude sample is calculated based on the sum of the calculated mathematical squares. In embodiments, where the acceleration data samples are unidimensional, the acceleration data samples may be used as the acceleration magnitude samples.

At block 815, a current acceleration magnitude sample is compared with a threshold acceleration value.

In response to the current acceleration magnitude sample being not greater than the threshold acceleration value, at block 805, the acceleration sensor or system accesses a next sample of acceleration data.

In response to the current acceleration magnitude sample being greater than the threshold acceleration value, at block 820, the acceleration sensor or system accesses a current acceleration data sample.

At block 830, if the acceleration data samples are multidimensional, a mathematical square of each of the acceleration data samples is calculated. In addition, a total acceleration or an acceleration magnitude sample is calculated based on the sum of the calculated mathematical squares. In embodiments, where the acceleration data samples are unidimensional, the acceleration data samples may be used as the acceleration magnitude samples.

At block 840, a current acceleration magnitude sample is compared with a current peak acceleration value.

In response to the current acceleration magnitude sample being greater than the current peak acceleration value, at block 850, the current acceleration magnitude sample is stored as an updated current peak acceleration value. In some embodiments, data related to the current acceleration magnitude sample is additionally stored. In response to the current acceleration magnitude sample not being greater than the current peak acceleration value, the current acceleration magnitude sample is not stored as an updated current peak acceleration value.

At block 860, a determination is made as to whether the current peak tracking

window has ended. If the current peak tracking window has not ended, at block 820, a next acceleration data sample is accessed.

If, at block 860, the current peak tracking window has ended, at block 870, data related to the current peak acceleration value is transmitted to a memory, such as a FIFO memory. In some embodiments, at block 870, data related to the current peak acceleration value is transmitted to an external circuit, such as a system controller.

At block 880, the memory used to store the data related to the current peak acceleration value is initialized, for example, to a zero value.

At block 885, the peak acceleration data stored in the memory at block 870 is received from the memory at a controller, such as a system controller. In addition, the peak acceleration data is analyzed by the controller. For example, in some embodiments, an acceleration peak magnitude is compared with a threshold value, and in response to the acceleration peak magnitude being greater than the threshold value, at 890, the controller may cause one or more actions to be taken. For example, the controller may cause the system to alert a user of the system or another party of a shock event. In some embodiments, the system sends a message to an emergency response system or agency. In some embodiments, the alert or message may include representations of various peak acceleration data. For example, the alert or message may include representations of one or more of: the magnitude of the peak acceleration, a direction of the peak acceleration, and a time of the peak acceleration. In some embodiments, the system stores an indication that the shock event occurred as an indication that a warranty of the system is no longer valid. In some embodiments, the system stores multiple threshold values, and determines actions to take based on which, if any of the multiple threshold values, the peak acceleration is greater than.

Examples of the present invention are summarized here. Other examples can also be understood from the entirety of the specification and the claims.

Example 1 One embodiment is an acceleration sensor circuit, including a package; an accelerometer configured to generate acceleration data samples during a peak tracking window; a sample register, configured to store the acceleration data samples; an acceleration calculation digital circuit, configured to calculate an acceleration magnitude sample based on the stored acceleration data samples; a peak register, configured to store a current peak acceleration value;

a sample compare circuit, configured to compare the acceleration magnitude sample to the current peak acceleration value, where the peak register is configured to replace the current peak acceleration value with the acceleration magnitude sample in response to the sample compare circuit determining that the acceleration magnitude sample is greater than the current peak acceleration value; and a memory, configured to store the current peak acceleration value, and to transmit the current peak acceleration value to an external circuit in response to an end of the peak tracking window, where the accelerometer, the sample register, the acceleration calculation digital circuit, the peak register, the sample compare circuit, and the memory are enclosed in the package.

Example 2: The acceleration sensor circuit of example 1, where the acceleration data samples are for each of three spatial dimensions, and where the acceleration calculation digital circuit is configured to calculate a mathematical square of the acceleration data samples for each of the three spatial dimensions, and to generate the acceleration magnitude sample based on a sum of the calculated mathematical squares.

Example 3: The acceleration sensor circuit of example 1 or 2, where the acceleration data samples are for each of two spatial dimensions, and where the acceleration calculation digital circuit is configured to calculate a mathematical square of the acceleration data samples for each of the two spatial dimensions, and to generate the acceleration magnitude sample based on a sum of the calculated mathematical squares.

Example 4: The acceleration sensor circuit of any one of examples 1-3, where the memory includes a first in first out (FIFO) memory structure.

Example 5: The acceleration sensor circuit of any one of examples 1-5, further including an acceleration threshold register configured to store an acceleration threshold value; and an acceleration compare circuit configured to compare the acceleration magnitude sample to the acceleration threshold value.

Example 6: The acceleration sensor circuit of example 5, further including a controller configured to, in response to the acceleration magnitude sample being greater than the acceleration threshold value, cause the sample compare circuit to compare the acceleration magnitude sample to the current peak acceleration value.

Example 7: The acceleration sensor circuit of examples 5 or 6, further including a controller configured to, in response to the acceleration magnitude sample being greater than the acceleration threshold value, initiate the peak tracking window.

Example 8: Another embodiment is a system, including a system controller; a plurality of system components configured to operate in response to control signals from the system controller; an acceleration sensor circuit package; an accelerometer configured to generate acceleration data samples during a peak tracking window; a sample register, configured to store the acceleration data samples; an acceleration calculation digital circuit, configured to calculate an acceleration magnitude sample based on the stored acceleration data samples; a peak register, configured to store a current peak acceleration value; a sample compare circuit, configured to compare the acceleration magnitude sample to the current peak acceleration value, where the peak register is configured to replace the current peak acceleration value with the acceleration magnitude sample in response to the sample compare circuit determining that the acceleration magnitude sample is greater than the current peak acceleration value; and a memory, configured to store the current peak acceleration value, and to transmit the current peak acceleration value to an external circuit in response to an end of the peak tracking window, where the accelerometer, the sample register, the acceleration calculation digital circuit, the peak register, the sample compare circuit, and the memory are enclosed in the acceleration sensor circuit package.

Example 9: The system of example 8, where the acceleration data samples are for each of three spatial dimensions, and where the acceleration calculation digital circuit is configured to calculate a mathematical square of the acceleration data samples for each of the three spatial dimensions, and to generate the acceleration magnitude sample based on a sum of the calculated mathematical squares.

Example 10: The system of example 8 or 9, where the acceleration data samples are for each of two spatial dimensions, and where the acceleration calculation digital circuit is configured to calculate a mathematical square of the acceleration data samples for each of the two spatial dimensions, and to generate the acceleration magnitude sample based on a sum of the calculated mathematical squares.

Example 11: The system of any one of examples 8-10, where the memory includes a first in first out FIFO memory structure.

Example 12: The system of any one of examples 8-11, further including an acceleration threshold register configured to store an acceleration threshold value; and an acceleration compare circuit configured to compare the acceleration magnitude sample to the acceleration threshold value.

Example 13: The system of example 12, further including an acceleration sensor controller configured to, in response to the acceleration magnitude sample being greater than the acceleration threshold value, cause the sample compare circuit to compare the acceleration magnitude sample to the current peak acceleration value.

Example 14: The system of example 12, further including an acceleration sensor controller configured to, in response to the acceleration magnitude sample being greater than the acceleration threshold value, initiate the peak tracking window.

Example 15: The system of any one of examples 8-14, where the system controller is configured to, in response to the current peak acceleration value, generate at least one of an alert and a message.

Example 16: Another embodiment is a method of forming an acceleration sensor circuit, the method including providing a package; providing an accelerometer configured to generate acceleration data samples during a peak tracking window; providing a sample register, configured to store the acceleration data samples; providing an acceleration calculation digital circuit, configured to calculate an acceleration magnitude sample based on the stored acceleration data samples; providing a peak register, configured to store a current peak acceleration value; providing a sample compare circuit, configured to compare the acceleration magnitude sample to the current peak acceleration value, where the peak register is configured to replace the current peak acceleration value with the acceleration magnitude sample in response to the sample compare circuit determining that the acceleration magnitude sample is greater than the current peak acceleration value; providing a memory, configured to store the current peak acceleration value, and to transmit the current peak acceleration value to an external circuit in response to an end of the peak tracking window; and packaging the accelerometer, the sample register, the acceleration calculation digital circuit, the peak register, the sample compare circuit, and the memory in the package.

Example 17: The method of example 16, where the memory includes a first in first out FIFO memory structure.

Example 18: The method of example 16 or 17, further including providing an acceleration threshold register configured to store an acceleration threshold value; providing an acceleration compare circuit configured to compare the acceleration magnitude sample to the acceleration threshold value; and additionally packaging the acceleration threshold register and the acceleration compare circuit in the package.

Example 19: The method of any one of examples 16-18, further including providing a controller configured to, in response to the acceleration magnitude sample being greater than the acceleration threshold value, cause the sample compare circuit to compare the acceleration magnitude sample to the current peak acceleration value; and additionally packaging the controller in the package.

Example 20: The method of example 16-18, further including providing a controller configured to, in response to the acceleration magnitude sample being greater than the acceleration threshold value, initiate the peak tracking window; and additionally packaging the controller in the package.

Example 21: Another embodiment is a method of using an acceleration sensor circuit, the method including detecting a signal indicating that a peak tracking window is to start; accessing acceleration data; calculating a current acceleration magnitude based on the acceleration data; in response to the current acceleration magnitude being greater than a current peak acceleration value storing the current acceleration magnitude sample as the current peak acceleration value; in response to the current acceleration magnitude sample not being greater than the current peak acceleration value, not storing the current acceleration magnitude as the current peak acceleration value; and in response to the peak tracking window having ended, transmitting data related to the current peak acceleration value to a memory, and initializing the current peak acceleration value.

Example 22: The method of example 21, herein the memory includes a first in first out FIFO memory structure.

Example 23: The method of example 21 or 22, further including generating the signal indicating that a peak tracking window is to start in response to a calculated acceleration magnitude being greater than an acceleration threshold value.

Example 24: The method of any one of examples 21-23, further including generating at least one of an alert and a message in response to the current peak acceleration value.

What is claimed is:

1. An acceleration sensor circuit, comprising:
a package;
an accelerometer configured to generate acceleration data samples during a peak tracking window;
a sample register, configured to store the acceleration data samples;
an acceleration calculation digital circuit, configured to calculate an acceleration magnitude sample based on the stored acceleration data samples;
a peak register, configured to store a current peak acceleration value;
a sample compare circuit, configured to compare the acceleration magnitude sample to the current peak acceleration value,
wherein the peak register is configured to replace the current peak acceleration value with the acceleration magnitude sample in response to the sample compare circuit determining that the acceleration magnitude sample is greater than the current peak acceleration value; and
a memory, configured to store the current peak acceleration value, and to transmit the current peak acceleration value to an external circuit in response to an end of the peak tracking window,
wherein the accelerometer, the sample register, the acceleration calculation digital circuit, the peak register, the sample compare circuit, and the memory are enclosed in the package.

2. The acceleration sensor circuit of claim 1, wherein the acceleration data samples are for each of three spatial dimensions, and wherein the acceleration calculation digital circuit is configured to calculate a mathematical square of the acceleration data samples for each of the three spatial dimensions, and to generate the acceleration magnitude sample based on a sum of the calculated mathematical squares.

3. The acceleration sensor circuit of claim 1, wherein the acceleration data samples are for each of two spatial dimensions, and wherein the acceleration calculation digital circuit is configured to calculate a mathematical square of the acceleration data samples for each of the two spatial dimensions, and to generate the acceleration magnitude sample based on a sum of the calculated mathematical squares.

4. The acceleration sensor circuit of claim 1, wherein the memory comprises a first in first out (FIFO) memory structure.

5. The acceleration sensor circuit of claim 1, further comprising:
an acceleration threshold register configured to store an acceleration threshold value; and
an acceleration compare circuit configured to compare the acceleration magnitude sample to the acceleration threshold value.

6. The acceleration sensor circuit of claim 5, further comprising a controller configured to, in response to the acceleration magnitude sample being greater than the acceleration threshold value, cause the sample compare circuit to compare the acceleration magnitude sample to the current peak acceleration value.

7. The acceleration sensor circuit of claim 5, further comprising a controller configured to, in response to the acceleration magnitude sample being greater than the acceleration threshold value, initiate the peak tracking window.

8. A system, comprising:
a system controller;
a plurality of system components configured to operate in response to control signals from the system controller;
an acceleration sensor circuit package;
an accelerometer configured to generate acceleration data samples during a peak tracking window;
a sample register, configured to store the acceleration data samples;
an acceleration calculation digital circuit, configured to calculate an acceleration magnitude sample based on the stored acceleration data samples;
a peak register, configured to store a current peak acceleration value;
a sample compare circuit, configured to compare the acceleration magnitude sample to the current peak acceleration value,
wherein the peak register is configured to replace the current peak acceleration value with the acceleration magnitude sample in response to the sample compare circuit determining that the acceleration magnitude sample is greater than the current peak acceleration value; and
a memory, configured to store the current peak acceleration value, and to transmit the current peak acceleration value to an external circuit in response to an end of the peak tracking window,
wherein the accelerometer, the sample register, the acceleration calculation digital circuit, the peak register, the sample compare circuit, and the memory are enclosed in the acceleration sensor circuit package.

9. The system of claim 8, wherein the acceleration data samples are for each of three spatial dimensions, and wherein the acceleration calculation digital circuit is configured to calculate a mathematical square of the acceleration data samples for each of the three spatial dimensions, and to generate the acceleration magnitude sample based on a sum of the calculated mathematical squares.

10. The system of claim 8, wherein the acceleration data samples are for each of two spatial dimensions, and wherein the acceleration calculation digital circuit is configured to calculate a mathematical square of the acceleration data samples for each of the two spatial dimensions, and to generate the acceleration magnitude sample based on a sum of the calculated mathematical squares.

11. The system of claim 8, wherein the memory comprises a first in first out FIFO memory structure.

12. The system of claim 8, further comprising:
an acceleration threshold register configured to store an acceleration threshold value; and
an acceleration compare circuit configured to compare the acceleration magnitude sample to the acceleration threshold value.

13. The system of claim 12, further comprising an acceleration sensor controller configured to, in response to the acceleration magnitude sample being greater than the acceleration threshold value, cause the sample compare circuit to compare the acceleration magnitude sample to the current peak acceleration value.

14. The system of claim 12, further comprising an acceleration sensor controller configured to, in response to the acceleration magnitude sample being greater than the acceleration threshold value, initiate the peak tracking window.

15. The system of claim 8, wherein the system controller is configured to, in response to the current peak acceleration value, generate at least one of an alert and a message.

16. A method of forming an acceleration sensor circuit, the method comprising:
providing a package;
providing an accelerometer configured to generate acceleration data samples during a peak tracking window;
providing a sample register, configured to store the acceleration data samples;
providing an acceleration calculation digital circuit, configured to calculate an acceleration magnitude sample based on the stored acceleration data samples;
providing a peak register, configured to store a current peak acceleration value;
providing a sample compare circuit, configured to compare the acceleration magnitude sample to the current peak acceleration value,
wherein the peak register is configured to replace the current peak acceleration value with the acceleration magnitude sample in response to the sample compare circuit determining that the acceleration magnitude sample is greater than the current peak acceleration value;
providing a memory, configured to store the current peak acceleration value, and to transmit the current peak acceleration value to an external circuit in response to an end of the peak tracking window; and
packaging the accelerometer, the sample register, the acceleration calculation digital circuit, the peak register, the sample compare circuit, and the memory in the package.

17. The method of claim 16, wherein the memory comprises a first in first out FIFO memory structure.

18. The method of claim 16, further comprising:
providing an acceleration threshold register configured to store an acceleration threshold value;
providing an acceleration compare circuit configured to compare the acceleration magnitude sample to the acceleration threshold value; and
additionally packaging the acceleration threshold register and the acceleration compare circuit in the package.

19. The method of claim 18, further comprising:
providing a controller configured to, in response to the acceleration magnitude sample being greater than the acceleration threshold value, cause the sample compare circuit to compare the acceleration magnitude sample to the current peak acceleration value; and
additionally packaging the controller in the package.

20. The method of claim 18, further comprising:
providing a controller configured to, in response to the acceleration magnitude sample being greater than the acceleration threshold value, initiate the peak tracking window; and
additionally packaging the controller in the package.

21. A method of using an acceleration sensor circuit, the method comprising:
detecting a signal indicating that a peak tracking window is to start;
accessing acceleration data;
calculating a current acceleration magnitude based on the acceleration data;
in response to the current acceleration magnitude being greater than a current peak acceleration value storing the current acceleration magnitude sample as the current peak acceleration value;
in response to the current acceleration magnitude sample not being greater than the current peak acceleration value, not storing the current acceleration magnitude as the current peak acceleration value; and
in response to the peak tracking window having ended, transmitting data related to the current peak acceleration value to a memory, and initializing the current peak acceleration value.

22. The method of claim 21, herein the memory comprises a first in first out FIFO memory structure.

23. The method of claim 21, further comprising generating the signal indicating that a peak tracking window is to start in response to a calculated acceleration magnitude being greater than an acceleration threshold value.

24. The method of claim 21, further comprising generating at least one of an alert and a message in response to the current peak acceleration value.
